(19) United States
(12) Patent Application Publication
(10) Pub. No.: US 2026/0276023 A1
(43) Pub. Date: Sep. 17, 2026

(54) Structural Fastener

(71) Applicant: Mag Daddy LLC, Wauconda, IL (US)

(72) Inventors: Bryan Smith, Ingleside, IL (US); Scott Schnur, Lake Zurich, IL (US)

(73) Assignee: Mag Daddy LLC, Wauconda, IL (US)

(21) Appl. No.: 19/667,663

(22) Filed: May 5, 2026

Related U.S. Application Data
(63) Continuation-in-part of application No. 17/405,030, filed on Aug. 18, 2021, now Pat. No. 12,644,484.
(60) Provisional application No. 63/800,412, filed on May 5, 2025.

(51) Int. Cl. F16B 37/04; F16B 39/282

(52) U.S. Cl. CPC F16B 37/046; F16B 39/282

(57) ABSTRACT

A nut operable for blind attachment between two rims on opposite sides of a strut. In one embodiment, the nut is a spin nut operable to rotate and lock onto the two rims on the strut. The spin nut includes a nut having a base, and a pair of wings formed on opposite sides of the nut, the wings being operable to engage the two rims. At least one locking surface is formed around the threaded hole in the nut to provide a prevailing torque. The locking feature may be embossed. A spring extends from the nut away from the strut and toward the two rims. A threaded hole may be formed in the nut extending into the base, such as a threaded nut, according to one embodiment. A bolt may be inserted into the threaded hole to attach to a bracket.

### FIELD OF THE INVENTION

The invention relates generally to devices for fastening objects, and more particularly to structural fasteners such as struts, pipe brackets, spring fasteners, strut hangers to secure construction components such as pipes, conduit, cables and so forth or to attach onto an engagement structure, such as a chassis, a strut, a hollow substrate, a wall, a plate or any suitable surface.

U.S. patent application Ser. No. 17/405,030 published application US 20210404504 assigned to Mag Daddy LLC discloses a nut for attachment to a strut channel and is incorporated by reference in its entirety. This US Patent Application claims priority to Ser. No. 17/405,030, filed on Aug. 18, 2021, and provisional patent application 63/800,412 filed on May 5, 2025.

### BACKGROUND OF THE INVENTION

A number of devices and fasteners in building construction are currently available to secure cables and/or for fastening threaded rods to struts, brackets, ceilings, frames, walls, roofs, fixtures, panels, body panels, building structure, and electrical conduit to the chassis or frame of a building. For example, spring nuts and other devices are used to secure bolts and threaded rods to a strut or truss. Clamps and cable ties are used to secure cables in electrical wiring and boxes. As used herein, a strut refers to a u-shaped bracket having holes to allow for attachment at various points and to facilitate a variety of construction situations. In their basic and conventional form, struts are used extensively in buildings however the conventional devices to attach to struts are time consuming to install and as a result are prone to incorrect and unstable assembly. The chassis of the building may include any substrate, plate, roof or ceiling support, structural framework, chassis component or subcomponent, support component, wall or any suitable object or combination.

Pipes may be hung and supported by the bottom of a u-shaped and/or clevis shaped bracket. The top of the bracket has a slot to allow a threaded rod and conventional nut above and another nut below to support the bracket. The threaded rod may then be attached to a chassis or building strut. However, both nuts must be turned and threaded from one end of the long rod. Once the pipe is installed, adjustment of the nut position requires supporting the weight of the pipe and rotation of both nuts. Such an attachment is time consuming and requires using both hands and is tedious and prone to improper assembly.

Attaching conduit, electrical boxes, wires or cables to a building structure, electrical box or body panel typically requires securing threaded rods with two bolts to support wires, cable clamps, electrical boxes, screw-in cable clamps, straps, tape or clips already fastened to a wire assembly. At least some of the fasteners require extended height or blind insertion and installation of the fasteners in difficult locations because the installer is not able to fully view the fastener or the mounting point on the body panel. These known fasteners require fastening with a wrench, ratchet wrench or screwdriver and thus are cumbersome and difficult to install, especially in inaccessible areas. Nor can they be installed without a wrench, ratchet or screwdriver for example on an electrical box, conduit or in automobile environments that can be difficult. Further, replacement of an installed, broken nut, rod or strut requires removal and can again be difficult and time consuming.

Conventional nuts such as hex nuts and spring nuts are placed by hand into a channel of a strut to attach to other structural components (e.g., another strut, cable hanger, bracket, etc.) and to the strut via a conventional nut. Further, two conventional nuts on either side of the strut are required to be separately spun and rotated and threaded onto the rod to clamp the rod in place into the strut. However conventional nuts require the installer to hold the nuts in place with one hand while rotating the threaded rod, then threading the second nut with their other hand, requiring two hands. A conventional nut or spring nut thus requires two hands since an installer inserts the nut and the spring between the channel back and the channel opening while rotating the threaded rod with their other hand.

### BRIEF DESCRIPTION OF THE DRAWINGS

FIG. 1A is a prior art channel nut without a spring;

FIG. 1B is a prior art channel nut with a spring;

FIG. 2 is a perspective view of a nut operable for blind attachment between two rims on a strut according to one embodiment;

FIG. 2A is a side view of a nut operable for blind attachment between two rims on a strut;

FIG. 3 is a view of a nut operable for blind attachment to a bracket and a strut;

FIGS. 4A and 4B are perspective top and bottom views of a nut for blind attachment according to one embodiment;

FIG. 5 is a view of two nuts operable for blind attachment to a bracket according to one embodiment;

FIG. 6 is an assembly view of the nut operable for blind attachment to a bracket supporting and forming a corner with two struts according to one embodiment;

FIG. 7 is a side view of the nut operable for blind attachment inserted into a strut channel before rotation into a strut channel prior to engagement with the rim of the strut;

FIG. 8 is a side view of the nut operable for blind attachment inserted into a strut channel and rotated to engage the rims on the strut according to one embodiment;

FIG. 9 is an enlarged view of the nut operable for blind attachment with the exit thread;

FIG. 10 is a view of the nut operable for blind attachment with the embossed feature and the exit thread;

FIG. 11 is a view of the nut operable for blind attachment having three embossed features;

FIG. 12 is a view of a nut operable for blind attachment having four embossed features; and

FIG. 13 is a bottom perspective view of the nut operable for blind attachment having a hole and an attached spring according to one embodiment.

### DETAILED DESCRIPTION OF THE PREFERRED EMBODIMENTS

A nut operable for blind attachment between two rims on opposite sides of a strut. According to one embodiment, the nut is a spin nut operable to rotate (spin) and lock onto the two rims on the strut. The nut includes a nut having a base, a pair of wings formed on opposite sides of the nut operable to engage the two rims. At least one locking surface (embossed feature) is formed around the hole to provide a prevailing torque. A spring extends from the nut away from the strut and toward the two rims. A threaded hole is formed in the nut extending into the base, such as a threaded nut, according to one embodiment. A bolt may be inserted into the threaded hole to attach to a bracket.

The fastener bolt passes through the spring side of the nut. As the bolt is tightened, interaction between the bolt threads and the locking surface increases friction, thereby causing the nut to rotate automatically into engagement with the rims of the strut. The prevailing torque or force is sufficient to turn the nut and then the nut will automatically fasten. The term prevailing torque refers to a level of frictional force applied to the radius or threads of the bolt to inhibit or prevent the nut and bolt from turning. For example, the frictional force at the threads of the bolt of about 15 pounds may be implemented although a range of 2 to 100 pounds or any suitable force or desired torque may be designed. Accordingly, the installer may quickly tighten the nut operable for blind attachment with a screw gun or anything suitable and it will automatically rotate with the screw and bolt right up.

During installation, the threads rotate to a height to adjust to a corresponding engagement height of the two rims. According to one embodiment, the threads are a symmetrical helix. Thus, the nut may be easily inserted into the channel of the strut and rotated such that the wings continuously adapt to variations in height of the rim in order to adjust the position of the strut. Thus, only a single nut need be used with a building, chassis or application even if different strut attachment lengths are required at different attachment points.

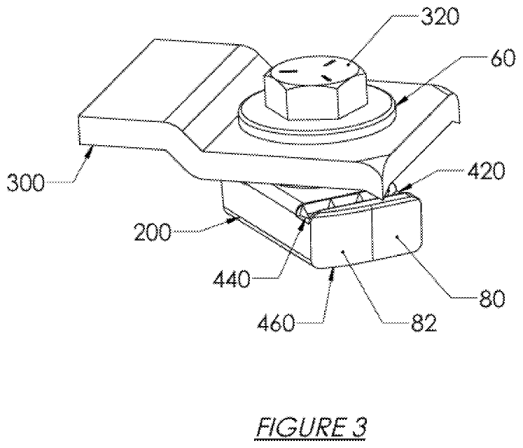

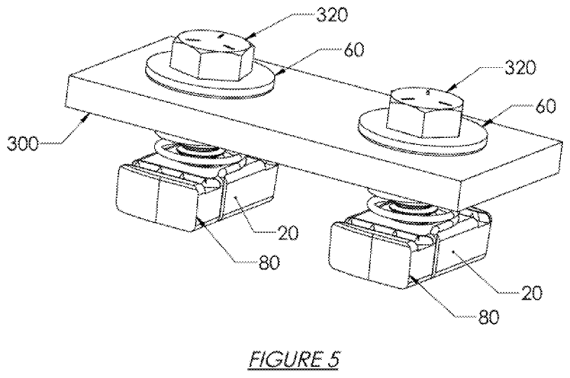

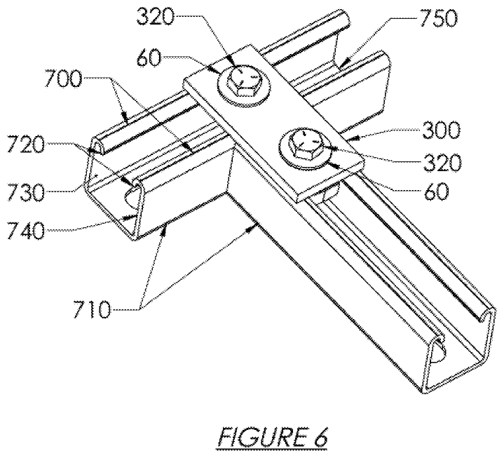

As shown in FIGS. 3, 5-6, the nut operable for blind attachment permits relatively easy attachment of the bracket. As shown in FIG. 6, in one embodiment, a corner bracket allows two struts to form a corner. The corner strut may be threaded onto a threaded rod and into a building chassis, pillar, structure, door, roof or suitable panel while providing a relatively high level of strength and support. Assembly of the nut operable for blind attachment onto the bracket and the struts reduces installation effort and may be performed with one hand and requires no or a relatively low level of installation effort and as a result provides many ergonomic advantages. The nut eliminates the need for threading a conventional nut on a long threaded rod, and thus significantly reduces the time to attach the nut to the threaded rod assembly. Also, the installer can attach the nut with one hand whereas the prior art conventional nuts require two hands to hold the nuts, thread the nuts onto the rod, insert, position and tighten onto the structural construction member. Also, conventional nuts do not self-align the nut with the channel, so readjustment of the conventional first and second nuts is required to align the rod to the strut. In contrast, the nut automatically self-aligns because the wings self-adjust onto the rims for engagement on the strut rim at a suitable height. Thus, no manual positioning or alignment of the nut or corner bracket is required.

The relatively easy attachment is particularly advantageous for operators who repetitively install multi sectioned nuts, brackets, corner brackets and struts onto the building or chassis. The relatively easy installation required for inserting the nut into the strut and the building results in fewer injuries to the assembly workers, including fewer injuries related to repetitive stress syndrome from rotating nuts onto long threaded rods. Further by selecting a single nut or reducing the number of different fasteners for fastening different strut lengths and thicknesses, it eliminates confusion during assembly since the same type or a reduced number of fasteners may be used for all or most struts. Thus, an electrician, installer, or assembly worker need not worry about selecting the wrong fastener.

The relatively high level of strength, characteristic of a rotating locking nut, securely attaches the strut and may also attach to the building or chassis. Further, the nut quickly and easily adjusts to the strut and eliminates or minimizes long tedious threading of nuts on the threaded rods, eliminating stripping threads, rounding hex nut edges, flexing of the threaded fastener and structural members, pushing and bending by operators, vibration and thermal expansion. For example, since conventional top and bottom nuts between the strut are required to clamp the strut, changes in length of the strut or rod requires untightening and re-tightening of the nuts. Conventional spring nuts often collapse or tilt causing the nut to tilt making threading the bolt difficult if not impossible requiring complete disassembly further wasting time reworking the strut. Another disadvantage of conventional spring nuts is that the installer has to estimate where on the strut the spring nut should be located so that if the spring nut is in the wrong position, then the installer must again disassemble and rework the strut attachment. To work around the problem, installers may cut off the spring further increasing the chance of the nut dropping into the strut channel.

In contrast, the nut is easily rotated in the strut slot and the nut may be easily rotated for blind engagement onto the strut rim and optionally moved along the strut rims for the desired position on the strut. The nut may also fasten to plastic and/or metal engagement structures. The nut may be made of anti-corrosive material such as plastic or treated metal to provide long reliable service life.

Yet another advantage is that the nut is relatively easy to manufacture using relatively inexpensive manufacturing processes and materials such as casting, cut or forged steel alloy or any suitable material. The use of the nut decreases installation effort and time, reduces assembly and construction costs, increases worker productivity and efficiency, improves reliability and quality and decreases overall assembly, warranty and maintenance costs. The nut improves reliability both in the short term and in the long term, while further improving safety and quality.

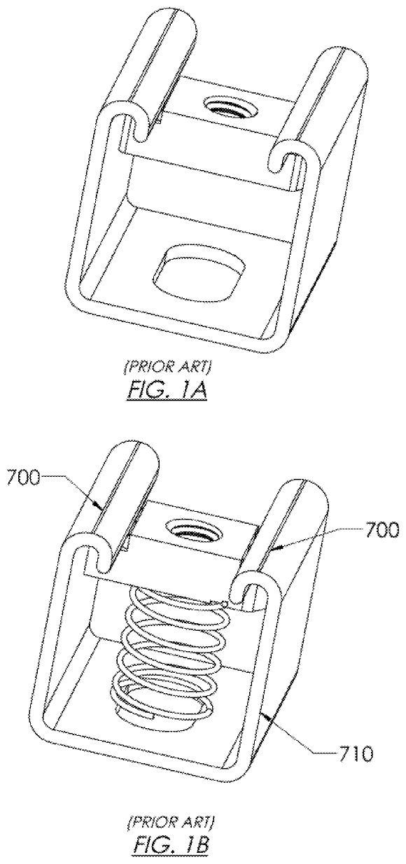

FIGS. 1A and 1B are prior art channel nuts without a spring and a channel nut with a spring that do not allow for blind attachment. FIG. 1A is a prior art channel nut without a spring. An installer needs to use one hand to hold the channel nut and the other hand to hold the strut while simultaneously inserting and rotating the channel nut, and while inserting a bolt into the channel nut. Thus, these conventional nuts are not capable of or operable for blind attachment. The installer will have to reattempt installation if the bolt does not thread onto the nut or the nut otherwise falls into the channel. FIG. 1B is a prior art channel nut with a spring. The spring faces the inside of the channel between the channel sides and away from the rims 700 of the strut 710. The spring temporarily pushes against the inside of the center channel of the strut pushing the channel nut into the rim so that the installer can insert the bolt and tighten the channel nut to the strut. However, the spring tends to collapse, snap out of the strut channel and require continuous adjustment manually until the position of the channel nut aligns with bracket holes. These prior art channel nuts require both hands and several manipulations by the installer and thus are not operable for blind attachment.

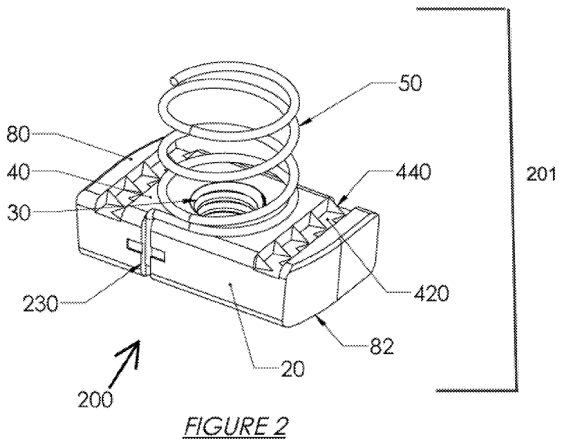

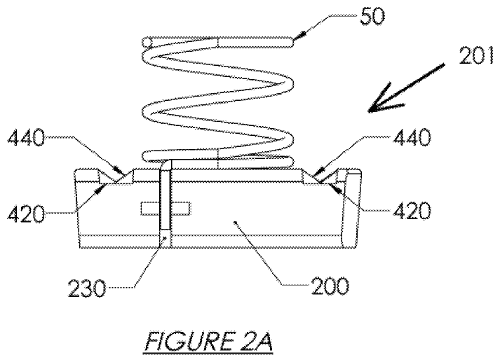

FIG. 2 is a side view of a spring nut 201 comprising a nut 200 and spring 50 operable for blind attachment to two rims 700 on a strut 710 according to one embodiment. The nut 200 includes a base or bottom 20 (see FIG. 2) having a thread 30 (such as a helical slope) having a locking surface 40, spring 50, a nut 200, an optional washer 60 (see FIG. 3) for attaching to and supporting a bracket 300 and a strut 710.

A channel 420 is formed on the nut 200 for engaging the rims 700 of the strut 710. Optionally, the channel 420 further includes embossed feature(s) 440 for providing additional engagement or gripping performance with the rims 700.

FIG. 2A is a side view of a spring nut 201 comprising a nut 200 and spring 50. Unlike the conventional spring nut, the spring 50 faces the rims 700 of the strut 710. Thus, the spring 50 extends in an opposite or upside-down direction compared to prior art spring nut as shown in FIG. 1B. A common problem with the prior art nut in FIG. 1B is that the spring must be placed by hand in the strut 710 and must be held by hand in place to not slip or fall out while the other hand threads a bolt into the nut. Unlike the prior art, the nut 200 does not require two hands. Spring 50 mounts into nut 200 such that the end of the spring 50 is inserted into the spring retention feature 230. The spring retention feature 230 is staked or embossed into the nut 200 such that the end of the spring 50 embeds and binds the spring 50 into the nut 200. The staking of the spring retention feature 230 such as a spring retention crimp slot results in a depression in the nut 200 and a flattening of the end of the spring 50 to embed the spring 50 into the nut 200.

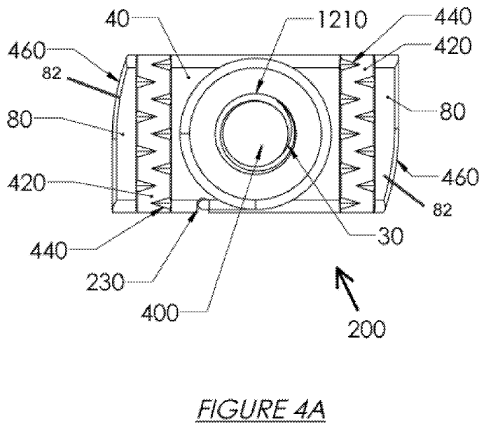

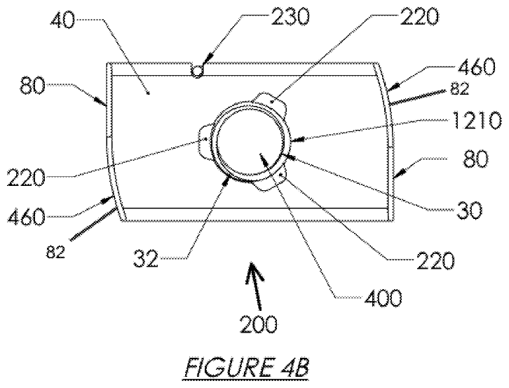

Embossed features 440 may be formed with tooling and a manufacturing process. Appropriate tooling and manufacturing processes may also make depressions to form locking surface 40 and prevailing torque embossed feature(s) 220 into the backside surface of the nut 200. The locking surface 40 may be crimped in the threads in order to provide sufficient threading resistance. The stamping process “moves” part material such as the steel used to form nut 200. For example, the countersink 1210 may be drilled such that the prevailing torque embossed feature 220 and the exit thread 32 exhibit less or minimal material displacement while maintaining the desired shape of prevailing torque embossed feature 220 and the exit thread 32. The prevailing torque embossed feature 220 may have any shape and size or quantity features suitable to engage the rim tips 720. For example, embossed feature 440 may include one or more gipping tooth feature such as prongs or any suitable shape and sized features as shown in FIG. 4A to guide, locate and stabilize the channel 420 on nut 200 to rim tips 720. The countersink 1210 may be formed around an outer circumference of the hole 400.

The at least one locking surface 40 may provide an appropriate amount of prevailing torque by forming a coating. The coating may be for example at least one of: nylon coated threads, glue, an embossed feature having a progressively increasing slope angle, a tapered hole, in-die tapping, or any suitable coating.

As shown in FIG. 9, a depression may form an prevailing torque embossed feature 220 into the backside of the nut 200, as the material is displaced. The depression causes the gap 910 on the exit thread 32 to slightly “crimp” or modify the gap 910 and pitch 1220 to tighten or close up the gap 910 causing the bolt 320 to be tighter on the exit thread 32. This provides a prevailing torque when then bolt thread 810 (FIG. 8) engages the exit thread 32, thus causing the nut 200 to rotate as the bolt 320 is tightened.

The nut 200 may be made or comprised of any suitable material such as: zinc die cast, machine steel, cast plastic, sintered powdered materials, or other similar materials. Other examples of sintered powdered materials include powdered metal, sintered (pressing powder together), plastic, vinyl, rubber, plastisol, plastic, acetal, polyacetal, polyoxymethylene, nylon, fiberglass, carbon fiber, or similar materials. Sintered refers to a process of compacting powdered materials and forming a solid mass of material by pressure or heat to a temperature below their melting point. Heat is applied without melting the powdered materials to the point of liquefaction, causing the particles to bond together and form a solid mass. This process, known as sintering, is commonly used in powder metallurgy to enhance the strength and density of materials without fully melting them. During sintering, particles diffuse across their boundaries, resulting in improved mechanical properties such as strength, hardness, and thermal stability.

The prevailing torque embossed features 220 formed around the hole 400 to provide a prevailing torque. The exit thread 32 may or may not exit on the prevailing torque embossed features 220. The exit thread 32 does not need to be directly on or over the prevailing torque embossed features 220. The exit thread 32 may be near or on the notches 22 or anywhere around the circumference of the threaded hole 400.

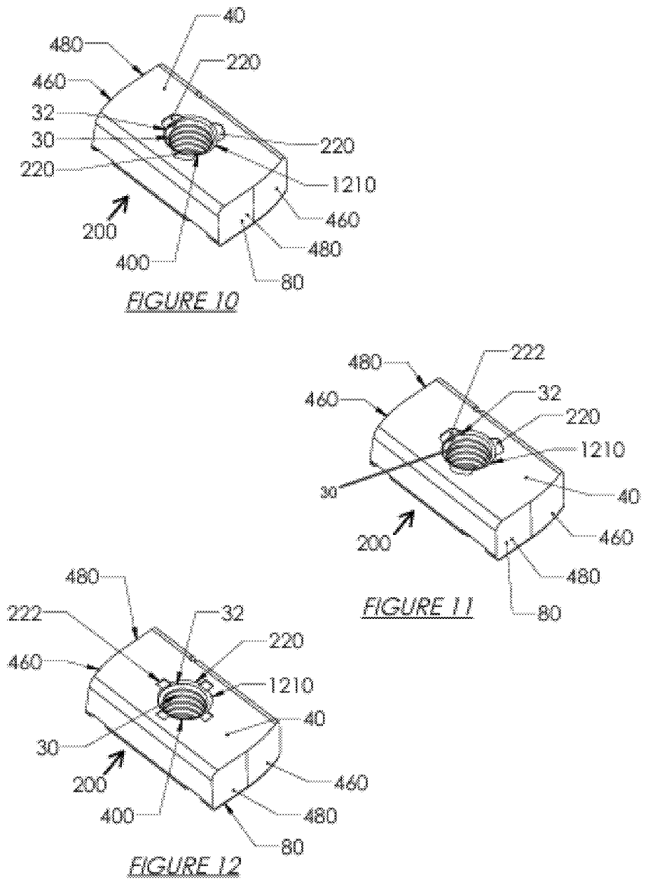

FIGS. 2, 4A, 4B, 9 through 13 show general features and thus contemplates many features such as at least one locking surface 40. Bolt 320 may be inserted into the (threaded) hole 400 to accept bolt 320 and secure and engage the at least one locking surface 40 to prevent and or resist bolt rotation and removal. The at least one locking surface 40 may include one or more prevailing torque embossed features 220 such as notches 222, according to one embodiment. According to one embodiment, the at least one locking surface 40 may include at least two prevailing torque embossed features 220, three embossed features 220 as shown in FIG. 11, or four prevailing torque embossed features 220 as shown in FIG. 12. The nut 200 is shown with the features in the drawings although any suitable features are contemplated such as one, two, three, four or more or any suitable number of notches 222, with any suitable shape and orientation.

As shown in FIGS. 2, 4A, 4B and 9-13 threads 30 form a symmetrical helix on the inside of a hole 400 extending into the base 20. According to one embodiment the hole 400 is threaded, forming threads 30. A fastener such as a bolt 320 may be inserted into the (threaded) hole 400 to accept bolt 320 and attach to a bracket 300. The nut 200 is operable to attach to a bracket 300 having a bracket slot and is operable to spin about the bolt 320 to adjust at an engaged position on the rims 700. The nut 200 includes channel 420 and optional embossed features 440 to engage rim tips 720 on rims 700.

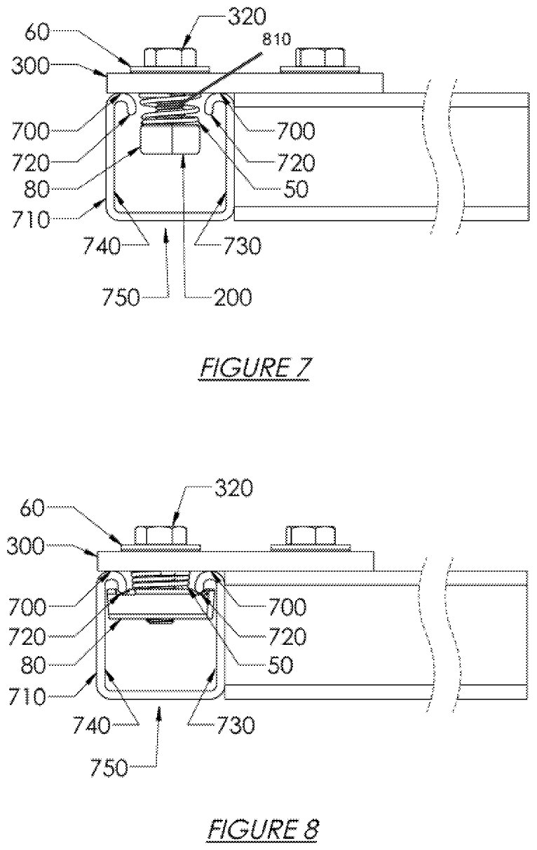

FIGS. 4B, 9, 10, 11, 12, 13 are perspective views of prevailing torque embossed features 220 according to one embodiment. At least one locking surface 40 such as prevailing torque embossed feature 220 formed around the hole 400 to provide a prevailing torque to rotate the nut 200 until the nut 200 engages rim tips 720 on rims 700 of the strut 710 as the bolt 320 rotates to progress the channel 420 into rim tips 720 (FIGS. 7 and 8).

The nut 200 and bracket 300 assembly (FIGS. 3, 4A, 4B, 5, 7, 8) may then couple the thread 30 on nut 200 via threaded rod or bolt 320. According to one embodiment, a pair of wings 80, 82 are formed on one side and another pair of wings 80,82 on the other side of the nut 200. The wing has an untapered portion 80 and a tapered portion 82. The tapered portion 82 may have a curvature 460 such that the curvature corresponds to respective contact surfaces 730, 740 on the two rims 700 when the nut 200 rotates so that it clears the respective contact surfaces 730, 740 of strut 710 (FIG. 7). The curvature of the tapered portion 82 may be curved, pointed flat, oval or any suitable curvature or shape to clear the contact surfaces 730, 740. The nut 200 continues to rotate until the untapered portion 80 engages the contact surface 730, 740 on the strut 710 to rotate and engage the two rims 700 of strut 710 (FIG. 8). The nut 200 stops rotating when the untapered portion 80 engages the strut 710. The untapered portion 80 engages the contact surfaces 730, 740 to provide sufficient prevailing torque or a counter torque so that the bolt threads into nut 200. Further rotating causes the bolt to tighten until the bolt and the nut 200 are in compression and thus compress the rims 700.

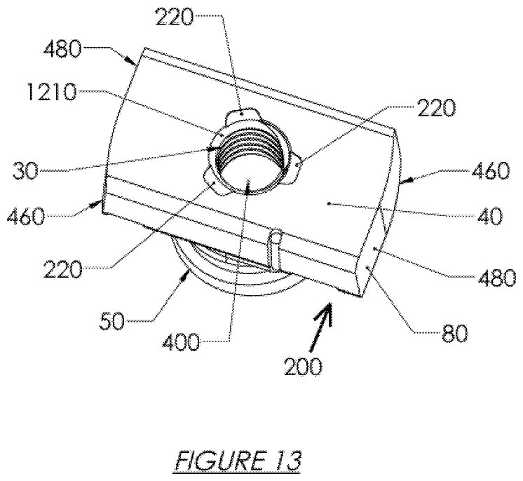

FIG. 13 is a bottom perspective view of the nut 200 having a hole 400 and an attached spring 50 according to one embodiment. Among other advantages, the spring 50 is on the same side as the rims 700 thus eliminating the possibility of the nut falling into the channel as shown in FIGS. 7 and 8. Instead of having to put the nut 200 in the strut 710 and then trying to find the spring 50, the installer can insert or slide the nut 200 right into the strut 710. This has the advantage of avoiding relatively expensive tooling to form threads in the pair of wings 80.

FIGS. 2A, 3, 7, and 13 are views of the nut 200 just before inserted and rotated into the rims 700 on the strut 710. The snap retainer or washer 60 is detachably coupled to the nut 200 and is operable to spring between bracket 300 and the spring 50. The washer 60 helps to hold nut 200 and avoid nut 200 from spinning while bolt 320 is turned and threaded into nut 200.

As shown in FIG. 2, the spin nut 200 includes the thread 30 having helical slope. The thread 30 having helical slope may be sloped axially relative to the nut 200, either angled positive or negative according to a suitable angle for the desired engagement height and degree of locking. The at least one locking surface 40 may be nylon coated threads, glue, an prevailing torque embossed feature 220 having a progressively increasing slope angle, a tapered hole, in-die tapping, or any suitable locking mechanism.

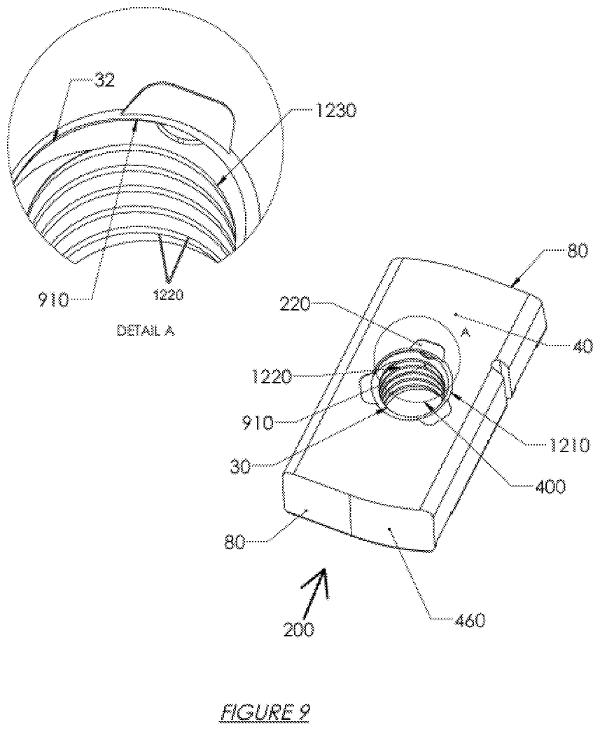

As shown in FIGS. 4A, B and 9-13, according to one embodiment thread 30 includes a plurality of prevailing torque embossed features 220. At least one thread 30 and exit thread 32 is formed on the nut 200. Alternatively, at least two prevailing torque embossed features 220 may be formed and thus may include 2, 3, 4 or more prevailing torque embossed features 220 or any suitable prevailing torque embossed features 220. According to one embodiment the nut 200 have three or four prevailing torque embossed features 220. In this embodiment, wing(s) 80 rotates and engages rims 700 in a continuous manner and engages to a large number or infinite increments of distances between the strut 710 and the bracket 300. The prevailing torque embossed features 220 can further lock or engage the threads 30 on nut 200 to strut 710. According to one embodiment the prevailing torque embossed features 220 as also shown in FIG. 9 includes a countersink 1210, a pitch 1220, and a peak 1230. FIG. 10 according to another embodiment shows locking surface 40.

FIG. 11 is an enlarged view of the spin nut 200 having three prevailing torque embossed features 220. FIG. 12 is an enlarged view of threads 30 having a symmetrical helix and four prevailing torque embossed features 220.

Although FIG. 11 shows three notches 222 and FIG. 12 shows four notches 222, any suitable number of notches 222 are contemplated such as 1, 2, 3, 4, 5, 6, 7, 8, 9, 10, 11, 12 or more. The shape of the countersink 1210, the pitch 1220 and the peak 1230 can be round, angled, curved, pointed, sharp, steep angle, or any suitable configuration to provide an appropriate level of engaging distance between the bolt 320 and the strut 710, and the degree of engagement or locking. For example, three notches 222 may be sized to cover a larger area around the circumference of the hole 400 than four or more notches. The number of prevailing torque embossed features 220 can be selected in order to allow for the displacement material due to the stamping to create prevailing torque embossed features 220. According to these embodiments, a plurality of prevailing torque embossed features 220 may be designed with a range of suitable shapes and dimensions. The threads 30 having the symmetrical helix further includes a plurality of prevailing torque embossed features 220 having a curvature corresponding to the surface contact on the threads of bolt 320.

FIG. 8 is a side view of the nut 200 inserted into a strut channel 750 and rotated to engage the tips 720 of rims 700 on the strut 710 according to one embodiment. During installation, the nut 200 may be easily inserted and clamped to a pair of rims 700. The nut 200 continuously adapts to variations in height in order to adjust to the position of the rims 700 on the strut 710. Thus, only a single nut 200 need be used in wide range of applications such as with a building, chassis or application even if different strut attachment lengths are required at different attachment points. A strut assembly may include at least one nut 200, at least one strut 710 and optionally one or more brackets 300.

FIG. 3 is a partially assembled view of a nut 200 operable to attach to a pair of rims 700 (as shown in FIG. 7) according to another embodiment. The nut 200 is operable to attach to the rims 700 by inserting into and pushing and then rotating a bolt 320 to engage the prevailing torque embossed features 220 on the thread 30. According to one embodiment, fastener is a threaded bolt 320, a rivet, pin, clamp, prong or any suitable fastener. The prevailing torque embossed features 220 may be tapered and have a countersink 1210 and a pitch 1220 that are angled such that the rims 700 engages along one of the pitch 1220 sections along the prevailing torque embossed features 220.

A washer 60 according to one embodiment is detachably coupled between the nut 200 and the bracket 300. The washer 60 may be a spring compression washer so that as bolt 320 is rotated then washer 60 is under compression in order to provide a pre-load between the thread 30 and the rims 700. Thus, the spring compression type of washer 60 allows the thread 30 when rotated to slide against the rims 700 gradually increasing the compression force between thread 30 and the rims 700. This compression force holds and stabilizes the nut 200 to prevent rotation. Thus, the spring compression washer 60 allows easy rotation of bolt 320 while holding the nut 200 so that bolt 320 threads through nut 200 until the washer 60 is sufficiently compressed or flattened and the nut 200 is in the locked position.

The prevailing torque embossed features 220 on the thread 30 engage an edge portion of the strut rims 700 when in a locked position, and countersink 1210 and a pitch 1220 to accommodate a lip or edge of the strut rims 700 to permit sufficient engagement with the rims 700 rim when rotating the nut 200. Prevailing torque embossed features 220 provides sufficient engagement of bolt 320 to allow the nut 200 to engage the strut rims 700. The nut 200 has a width similar to or slightly smaller than the width of strut rims 700 in order to insert the nut 200 into the strut rims 700 and to sufficiently engage the bracket slot and provide the desired amount of stability during installation and engagement. According to one embodiment, nut 200 and the bracket slot has tapered wings 80 having a corresponding circular, round, hexagonal, square shape or any suitable shape with rounded edges, to avoid radius interference. The tapered wings 80 may have a flange with a length that is greater than width and aids with inserting the nut 200 into the bracket slot. The wing 80 may be shaped with rounded edges on nut 200 shown in FIG. 2 are sized such that a radius from the center of the nut 200 allows insertion of the wing 80 into the strut channel to the closest edge of the strut and permits rotation in the channel or bracket 300. The tapered wings 80 have an outer shape to allow the nut 200 to rotate in only one direction and to lock in the tightening position.

As shown in FIG. 2 the width of the neck on nut 200 is sized slightly narrower than the slot width between rims 700 to permit insertion of the nut 200 into the slot. The nut 200 may be continuously rotated wherein the spin nut 200 is operable to spin to adjust to any suitable position on the rims 700. The wing 80 on the nut 200 rotate any number of rotations or degrees to obtain the desired height and engagement onto rims 700.

According to one embodiment, countersink 1210 and pitch 1220 on each of the prevailing torque embossed features 220 prior to tapping threads 30 aids to prevent breaking the tapping tool. This is especially advantageous when performing each step in a progressive tool to form threads in the nut 200. For example, the process begins first with 1) drilling the hole, 2) countersink 1210 the hole and then 3) tap to form threads 30. If the countersink 1210 is formed after forming the threads 30, the threads 30 may close up and or form metal pieces that risk damaging the threads 30.

As shown in FIGS. 9, 10, 11, 12, the three or four prevailing torque embossed features 220 are matching to line up with the exiting taper thread 32. Among other advantages, the exiting taper thread 32 lined up on the exiting part of the hole 400 aligns the threads 30 around the bolt 320 and actuates as it is exiting the prevailing torque embossed features 220. For example, the one exiting taper thread 32 that does exit can be anywhere around that circumference of the locking surface 40. In order to align the prevailing torque embossed features 220 with the exiting taper thread 32, the width of the prevailing torque embossed features 220 is maximized or made a sufficient width provides the prevailing torque. The exiting taper thread 32 and the thread 30 provide a screw or bolt 320 to be loosely threaded as normal by hand through to the backside of the threads 30 with slight resistance on the exit thread 32 that causes the nut 200 to turn and hold in the engaged or clamped position within the strut 710 as the bolt 320 is threaded through the exit thread 32 as it is tightened.

During machining in the manufacturing process, for the exiting taper thread 32 to be cut without breaking the tap tool, or leaving a burr, a countersink 1210 may be drilled on both sides before tapping the thread 30. The taper of the tap tool needs to fully thread through the thread 30. Since stamping during the embossing process displaces material, the countersink 1210 process is controlled to cut away the sharp corner, but still leave material near the exiting taper thread 32 to displace. The exiting taper thread 32 goes through the countersink 1210 on the surface of the nut 200. The exiting taper thread 32 determines how the bolt 320 threads into the hole 400. A die tap can alter the exiting taper thread 32 to slightly tighten the thread 30 around the bolt thread. The prevailing torque embossed features 220 may be close to the exiting taper thread 32 around the circumference of the hole 400 so the prevailing torque embossed features 220 displaces material within the exiting taper thread 32. According to one embodiment, the prevailing torque embossed features 220 crimps the thread slightly resulting in the prevailing torque between the bolt 320 and the exiting taper thread 32. The countersink 1210 breaks the sharp edge of the hole 400. The major diameter of the countersink 1210 may be slightly larger than the outside diameter position of the exiting taper thread 32. To form a countersink 1210 on both sides of the nut 200, a hole is drilled through the nut 200 on both sides and a cutting tap tool cuts the threads through the nut 200. The diameter of the through hole 400 is determined by the thread size and type to be tapped. The countersink 1210 chamfers the edges of the through hole 400 before tapping to break the sharp edges of the hole 400 and acts a lead-in for the tap tool. This eliminates the sharp edges to allow the tap to cleanly cut into the nut 200 more freely with less force and without leaving surface burrs. The major diameter of the countersink 1210 is sized to be slightly larger than the major diameter of the tap. The exiting taper thread 32 is cut through the countersink 1210 area. Among other advantages, the spring nut 201 may be installed with blind attachment even with one hand by threading bolt 320 into the spring nut 201 with a suitable prevailing torque.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

What is claimed is:

1. A spring nut operable for blind attachment between two rims on opposite sides of a strut, comprising:
a nut having a base;
a pair of wings formed on opposite sides of the nut to engage the two rims;
a hole having threads formed in the nut extending into the base;
at least one locking surface formed around the hole to provide a prevailing torque; and
a spring extending from the nut and away from the strut and toward the two rims.

2. The spring nut operable for blind attachment of claim 1, further including a countersink formed around an outer circumference of the hole.

3. The spring nut operable for blind attachment of claim 1, wherein the pair of wings have a curvature on opposite ends of the pair of wings such that the curvature corresponds to contact surfaces on the two rims.

4. The spring nut operable for blind attachment of claim 1, wherein as the nut is rotated, the wings engage the two rims.

5. The spring nut operable for blind attachment of claim 1, wherein the at least one locking surface is at least one of: nylon coated threads, glue, an embossed feature having a progressively increasing slope angle, a tapered hole, and in-die tapping.

6. The spring nut operable for blind attachment of claim 1, wherein the two rims are formed on a channel of a strut such that the nut is inserted in between the two rims and rotated until the wings engage the two rims in an engaged position.

7. The spring nut operable for blind attachment of claim 1, wherein the nut is comprised of at least one of: zinc die cast, machine steel, cast plastic or powdered metal, sintered powdered materials, plastic, vinyl, rubber, plastisol, plastic, acetal, polyacetal, polyoxymethylene, nylon, fiberglass, carbon fiber, or similar materials.

8. The spring nut operable for blind attachment of claim 1, wherein the threads are helical, and the nut accepts a threaded bolt.

9. The spring nut operable for blind attachment of claim 1, wherein the threads are formed in the nut and a bolt attaches a bracket and engages the spring as the bolt is threaded into the hole, such that the at least one locking surface provides the prevailing torque to rotate the nut until the nut engages rims of the strut as the bolt rotates.

10. The spring nut operable for blind attachment of claim 9, wherein the bolt attaches to a bracket to the hole having threads via the spring and a spring compression washer.

11. The spring nut operable for blind attachment of claim 9, wherein the bolt further includes threads to engage an exit thread on the threads formed in the nut.

12. The spring nut operable for blind attachment of claim 1 wherein the at least one locking surface is at least two embossed features.

13. The spring nut operable for blind attachment of claim 1, wherein the at least one locking surface is at least one notch.

14. The spring nut operable for blind attachment of claim 1, wherein the nut rotates to a height to adjust to a corresponding engagement height of the two rims.

15. A strut assembly and spin nut operable for blind attachment between two rims on
a strut and a bracket comprising:
a nut having a base;
a pair of wings formed on opposite sides of the nut operable to engage the two rims;
a threaded hole formed in the nut extending into the base for threading a bolt into the threaded hole operable to attach to a bracket having a hole and operable to spin the bolt and to adjust to a position on the two rims on the strut;
at least one locking surface formed around the hole to provide a prevailing torque to rotate the nut until the nut engages rims of the strut as the bolt rotates; and
a spring extending from the nut away from the strut and toward the two rims.

16. The strut assembly and spin nut of claim 15, further including a countersink formed around an outer circumference of the hole.

17. The strut assembly and spin nut of claim 15, wherein the at least one locking surface is at least one of: nylon coated threads, glue, an embossed feature having a progressively increasing slope angle, a tapered hole, and in-die tapping.

18. The strut assembly and spin nut of claim 15, wherein the bolt attaches to a bracket and engages the spring as the bolt rotates and is threaded into the threaded hole, such that the at least one locking surface provides the prevailing torque to rotate the nut until the nut engages the two rims of the strut.
